(19) United States
(12) Patent Application Publication
(10) Pub. No.: US 2005/0042586 A1
(43) Pub. Date: Feb. 24, 2005

(54) Behavior board

(76) Inventors: Deborah Lynn Carpenter, Tyngsboro, MA (US); Jeffrey Paul Carpenter, Tyngsboro, MA (US)

Correspondence Address: Pearson & Pearson LLP, 10 George Street, Lowell, MA, 01852, US

(21) Appl. No.: 10/644,988

(22) Filed: Aug. 21, 2003

(51) Int. Cl. G09B 19/00

(52) U.S. Cl. 434/238

(57) ABSTRACT

A behavior modification device and system to allow parents, caregivers and educators to change unwanted and/or undesirable behavior in children. The device consists of a cardboard, plastic or wooden base panel with one or more removable cardboard, plastic or wooden cards. The cards are double-sided. The cards serve as extrinsic secondary reinforcers or punishers. One side displays a positive reinforcer, such as a ‘happy face’ or ‘smiley’. The other side displays a punisher, such as a ‘sad face’ or ‘frown’. The cards will be secured to the base panel with suitable attachment means. The base panel will also be equipped with velcro or magnetic attachments to mount in an easy-to-see area. The position of the cards will provide a visual cue of how well a child is performing a desired behavior. At the end of a predetermined period of time, this simple device can be used to determine if a child is eligible to receive a reward.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, a TABLE, or a COMPUTER PROGRAM LISTING COMPACT DISK APPENDIX

“Not Applicable”

### BACKGROUND OF THE INVENTION

This invention relates in general to card, picture or sign exhibiting. More specifically, it pertains to a device that simplifies the process of modifying the behavior of children.

This invention is based on the belief that the real-world application of operant conditioning techniques can and will modify the behavior of children. Operant conditioning is based on the principle of voluntary behavior. It is believed that a behavior or act followed by pleasant or rewarding consequences is more likely to be repeated. A behavior or act followed by negative consequences, such as the withdrawal of pleasant consequences or the application of punishment, is less likely to be repeated. Therefore, it is understood that the consequences of a behavior or act will likely affect the probability of that behavior or act occurring again.

Research has shown that methods of punishment such as spanking, yelling, ignoring and time-outs can be inefficient and ineffective. In addition, most parents, caregivers and educators administer punishment inconsistently and/or ineffectively. This can result in confusion and frustration in both the punisher and the child. In order to punish effectively, a parent, caregiver or educator would need to be certain the punishment fit the offense, that it was age appropriate and effective in their absence. The punishment must be administered immediately and with explanation of wrongdoing. It must be administered without giving the offender too much attention, therefore inadvertently negatively reinforcing the unwanted behavior. The punishment must be followed by consistent reinforcement of the desired behavior. And, above all, it must be used consistently. The average parent, caregiver or educator would find remembering to apply so many rules difficult and overwhelming. Furthermore, as any parent knows, punishing a child can be an emotionally charged situation.

This invention will create a more objective environment by allowing clear communication of behavioral expectations and the resulting rewards and/or consequences of a child's behavior. The child knows, ahead of time, what is expected and what the consequences will be if those expectations are not met. With the simple flip of a card (i.e. from the positive reinforcer side of the card to the punisher side of the card) parents, caregivers and educators can convey instantly the status of (or progress toward) a reward. A child will quickly learn to strive for the positive reinforcer in pursuit of the reward. A child will also quickly learn that the flip of the positive reinforcer card to the punisher side indicates the removal of a reward. The overall amount of day-to-day punishment necessary should decrease with the consistent use of this invention

This invention was designed primarily to give parents a simple hands-on tool that allows them to teach a child that desirable behavior or actions will be followed by a reinforcer and/or reward and that undesirable behavior or actions will be followed by withdrawal of a reinforcer and/or reward.

Historically, behavior modification has enjoyed great success in settings such as classrooms, prisons, offices, child care centers, mental hospitals, rehabilitation centers, and nursing homes. Behavior modification has been credited for eliminating many unwanted behaviors, such as smoking, nail biting and overeating. It has helped many people acquire desired behaviors such as improved study, healthy eating and exercise.

This invention utilizes those same successful behavior modification principles in a simplified form to provide parents, caregivers and educators a proven method of improving the behavior of young children. Effective behavior modification is not only a science, but an art. Therefore, the invention is basic enough in design to allow for it's use in a variety of situations at a variety of ages and developmental stages.

### DESCRIPTION OF THE RELATED ART

Discipline has been the subject of many discussions and arguments among parents, caregivers and educators. Thousands of books and magazine articles have attempted to guide and instruct parents and educators in the art of effective discipline. Each individual, family and school system has had to research the various approaches to discipline, devise a plan, carry out that plan, then revise and review that plan as it either succeeds or fails.

The present invention responds to the need for simple, effective discipline of children. The behavior board, using proven behavior modification principles, allows parents, caregivers and educators to convey clear behavioral expectations. When used correctly, the behavior board provides instant reinforcement and/or reward of a desired behavior or act. The behavior board also provides instant punishment for an undesirable behavior or act. The board is intended to be used for only one child at a time. If used in an educational setting, each child may have an individual board, or the class as a whole could be represented by one board. The behavior board should be visible at all times. In real-life settings, consistency of use will greatly increase the overall effectiveness of the behavior board. A discussion of the related art of which the present inventor is aware, and it's differences and distinctions from the present invention, is provided below.

U.S. Pat. No. 3,782,009 issued on Jan. 1, 1974 to Eula K. Darnell, titled “Behavior Modification Point Board,” comprises a board having a plurality of column and row slots. A leftmost column provides for the names of the plurality of students, while an upper row provides a list of desirable traits, habits, tasks to be completed, etc. A marker is placed within the corresponding slot whenever a student completes one of the upper row items satisfactorily. The markers can be later exchanged for a reward. The Darnell board is used primarily with school-age children for the completion of tasks. This board is used primarily as a motivator using the principle of positive reinforcement. There is no punishment provided by the Darnell board, as provided by the present invention.

U.S. Pat. No. 5,470,235 issued on Nov. 28, 1995 to Stephen Papaleo, titled “Child Behavior Improvement System,” comprises a support member having a plurality of receptacles, means for defining a reward disposed in each of said receptacles, cover means to identify desirable behavior, and said means being partially removable for access to said reward. Papaleo's receptacle is hands-on and meant to be accessed by the child. The system is meant for use by school-age children and uses a series of steps such as ‘do this’ ‘with this’ like this’. This process would be too complicated for a young child. In addition, the system is fairly labor intensive on the part of the parent or counselor. The behavior improvement system also makes no provision for punishment.

U.S. Pat. No. 5,573,405 issued on Nov. 12, 1996 to Suzanne Evans, titled “Behavior Monitoring and Training Device,” comprises a peg board arranged in a predetermined pattern such as a grid of rows and columns. Indicator plates marked with visual indicia represent individuals, tasks and behaviors. The plates slide onto the pegs. The plates are positioned on the board to assign tasks to specific individuals and to indicate behavior traits to be modified. The Evans invention contains a task section and a behavior section addressing existing behaviors and desired behaviors. The complexity of this invention makes it unlikely to be used with young children. The device does not disclose a mechanism for immediately signaling a reversal from good to bad or bad to good. The use of multiple plates on a single peg will also increase the complexity of it's use.

U.S. Pat. No. 5,573,404 issued on Nov. 12, 1996 to Wlllard S. Stawski, II, titled “Device and Process for Modifying Behavior of Children,” comprised of a recording implement having a group of interrelated columnar items of a person's behavior, with an assigned monetary value to each. The device is constructed as a sheet of printable paper or plastic material secured to the refrigerator or other suitable surface. It is to be used as the basis for payment of allowance. Stawski, II relies on the principle of positive reinforcement for completion of chores. Since a monetary allowance is being tallied, this invention is for use with older children. It's use is limited to payment of an allowance.

U.S. Pat. No. 5,697,790 issued on Dec. 16, 1997 to Antonia Garland and Rebecca Tomzik, titled “Discipline System,” comprises a caregiver selecting a plurality of tokens in response to misbehavior of the child and instructing the child of a suitable token phrase relating to the misbehavior. The child places at least one of the tokens into a first portable container and repeats the token phrase. This is repeated multiple times. This system is good in that the punishment is immediate and involves action on the part of the child. Not so good in that Garland and Tomzik provide no means for a reward system. This discipline system focuses solely on punishing the misbehavior. Also, carrying out the punishment requires constant supervision and creativity on the part of the caregiver.

U.S. Pat. No. 5,954,512 issued on Sep. 21, 1999 to David M. Fruge, titled, “Behavior Tracking Board” comprises a board for maintaining a record of the behavior of one or more children or individuals over a period of time. The board comprises one or more horizontal rows, with each row corresponding to a single individual or child. Each of the rows includes a movable marker captured in a track therealong, with the markers initially being placed in the extreme right position of their respective tracks. As time progresses, the markers are moved leftward along the track when less than desirable behavior occurs. Fruge uses a continuum of good to bad behavior. This is potentially confusing to young children as behavior is being measured over a period of time without rewarding or punishing specific behaviors or acts. Moreover, the plurality of users (i.e. more than one child being tracked on a single board) can inadvertently set up a competitive atmosphere.

Finally, U.S. Pat. Appl. 20030070332 issued on Apr. 17, 2003 to Cathy D. Santa Cruz and James W. Hinton, titled, “Multipurpose Display Device and Method of Use,” comprises a novel display device being in the form of a mounting card having a removable symbol and a removable strip thereon, with the method comprising the steps of: grasping said mounting card, grasping said symbol and manually removing said symbol from said mounting card. Then attaching said symbol onto a support surface, grasping said strip and manually removing strip from said mounting card to attach said strip onto said symbol. The device intends to stimulate an emotional response when viewed by including a symbol and a message (i.e. The symbol of a patriotic bow with a black ribbon ‘message’ attached. The black ribbon ‘message’ indicates a state of war. The ribbon will be removed when the war is over). While Santa Cruz and Hilton use a display device, it is meant simply to convey a message and hopefully invoke an emotional response. The display device is not meant to be used in connection with a behavior modification program, nor is it meant to be used with children.

None of the above inventions and patents is seen to describe the instant invention as claimed.

### BRIEF SUMMARY OF THE INVENTION

The goal of the behavior modification device is to provide parents, caregivers and educators with a simple behavior modification system for use with children predominantly between the ages of 2 and 8. In keeping with real-world application of operant conditioning techniques, this device allows parents, caregivers, and educators to use behavior modification to set clear and consistent behavioral goals. This device was designed primarily to provide a simple hands-on tool that allows them to teach a child that desirable behavior or actions will be followed by a reinforcer and/or reward and that undesirable behavior or actions will be followed by withdrawal of a reinforcer and/or reward. This simple, visually effective device allows the user to keep a running record of desirable and undesirable behavior with the flip of a card.

### BRIEF DESCRIPTION OF THE DRAWINGS

FIG. 1 This figure is an overview of the preferred embodiment for the present invention and illustrates the front side of the behavior modification base panel featuring three attachment means.

FIG. 2 This figure is an overview of the preferred embodiment for the present invention and illustrates the back side of the behavior modification base panel featuring various attachment means.

FIG. 3 This figure is an overview of the preferred embodiment for the present invention and illustrates the front side of the base panel. Three removable, double-sided cards displaying the reinforcing front side are shown attached to the base panel.

FIG. 4 This figure is an overview of the preferred embodiment for the present invention and illustrates the front side of the base panel. Three removable, double-sided cards displaying the punishing back side are shown attached to the base panel.

FIG. 5 This figure illustrates the front side of the base panel with three removable, double-sided cards attached. Two cards are attached in the positively reinforcing position and one card is shown in the punishing position.

FIG. 6 This figure illustrates the removable, double-sided cards.

### DETAILED DESCRIPTION OF THE DRAWINGS

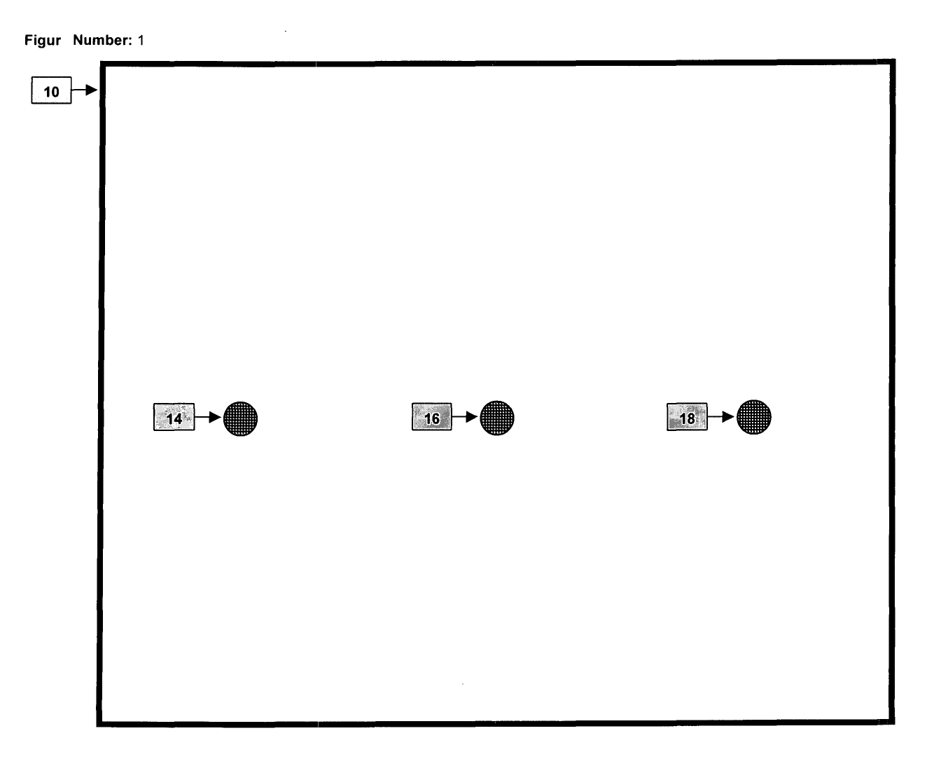

Referring in detail to FIG. 1, a simple embodiment of the front side of the base panel (10) of the present invention is illustrated. The base panel (10) is comprised of a thin, flat generally rectangular sturdy base. It is constructed of cardboard, chipboard, plastic, wood or other suitable construction material or combination of construction materials. The front side of the base panel (10) contains three attachment means (14,16,18) mounted in the middle of the panel. There may be any number of attachment means (14,16,18) mounted on the front side of the base panel (10) depending on the scope of application.

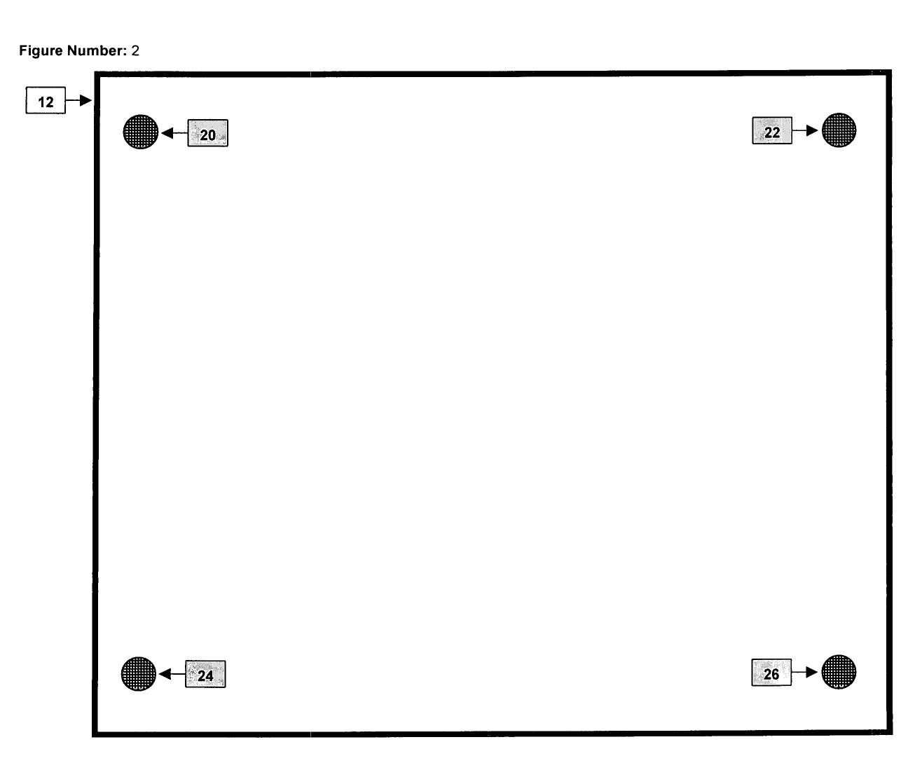

Referring in detail to FIG. 2, a simple embodiment of the back side of the base panel (12) of the present invention is illustrated. The back side of the base panel (12) can be mounted onto any suitable surface, such as refrigerator, bulletin board, wall or any other easy-to-see area. Symbols (20,22,24,26) display attachment means in the corners of the back side of the base panel (12). It is understood that any attachment means may be used, such as magnets, velcro, suction cups or other suitable attachment devices.

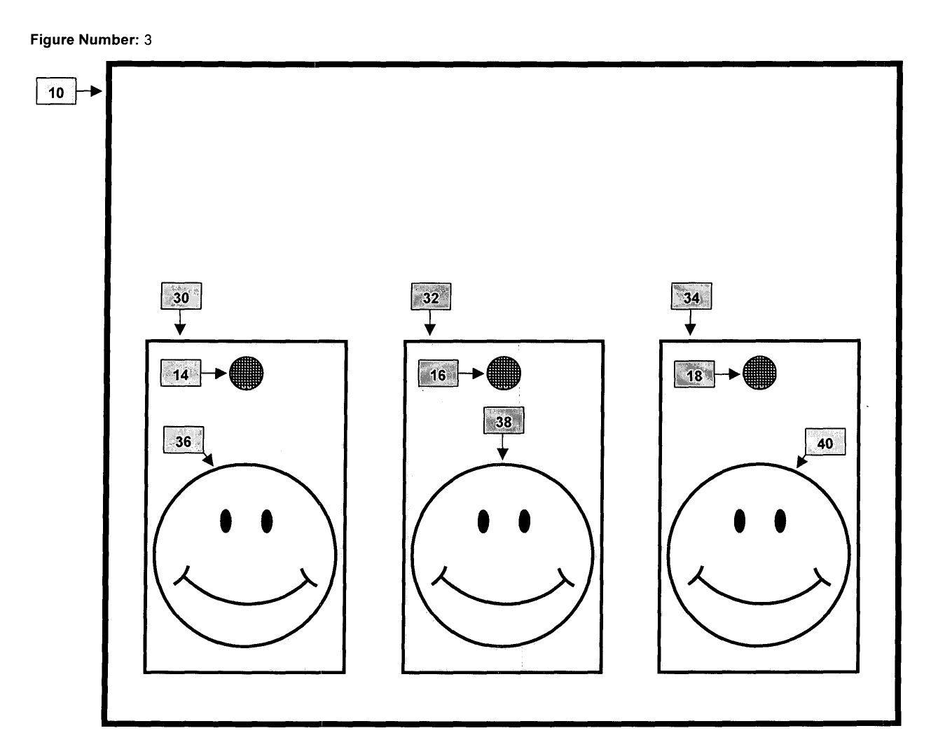

Referring in detail to FIG. 3, a simple embodiment of the front side of the base panel (10) displaying the front side of the removable, double-sided cards (30,32,34). There will be marking indicia (36,38,40) on the front side of the removable, double-sided cards (30,32,34). In this illustration, the marking indicia (36,38,40) is of a ‘happy face’ or ‘smiley’. It is understood that other marking indicia or pictorial representations may be used in place of the basic ‘happy face’ or ‘smiley’ designations. The removable, double-sided cards (30,32,34) are shown attached (14,16,18) to the front side of the base panel (10).

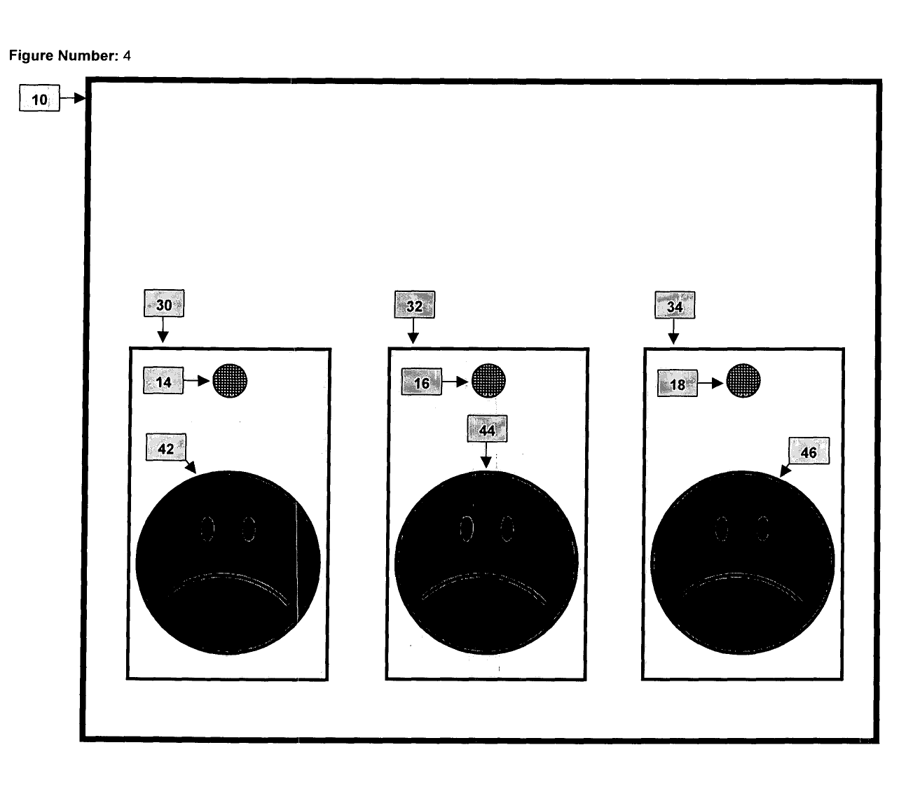

Referring in detail to FIG. 4, a simple embodiment of the front side of the base panel (10) displaying the back side of the removable, double-sided cards (30,32,34). There will be marking indicia (42,44,46) on the back side of the removable, double-sided cards (30,32,34). In this illustration, the marking indicia (42,44,46) is of a ‘sad face’ or ‘frown’. It is understood that other marking indicia or pictorial representations may be used in place of the basic ‘sad face’ or ‘frown’ designations. The removable, double-sided cards (30,32,34) are shown attached (14,16,18) to the front side of the base panel (10).

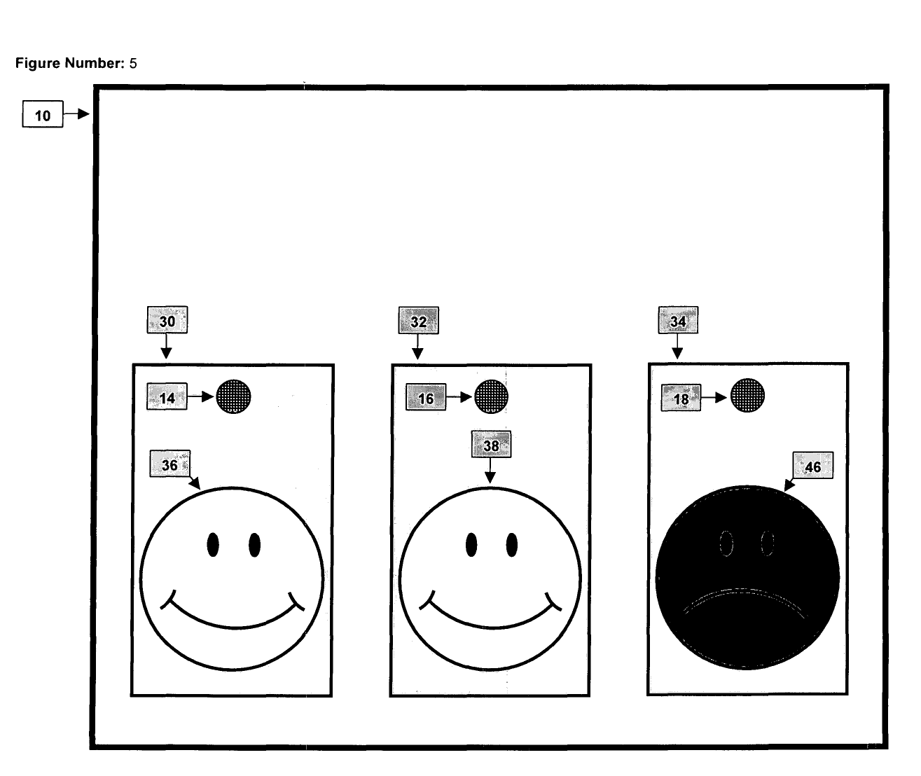

FIG. 5 displays the front side of the base panel (10) with three removable, double-sided cards attached. Two cards (30,32) are attached in the positively reinforcing position (36,38) and one card (34) is shown in the punisher position (46). FIG. 5 illustrates the behavior modification device in use. One of the positively reinforcing cards (40) has been detached (18) from the front side of the base panel (10) and has been reattached (18) to the front side of the base panel (10) in the punisher (46) position. In use, this would mean that said child had performed an undesired behavior or act.

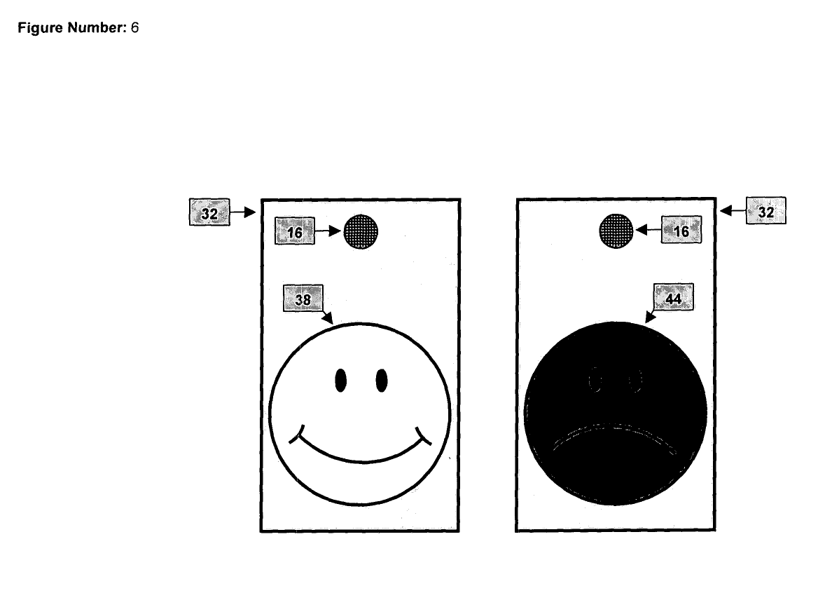

FIG. 6 displays the reinforcing (38) front side and the punishing (44) back side of the removable, double-sided card (32). Both the reinforcing (38) front side and the punishing (44) back side of the removable, double-sided card contain an attachment means (16) in the center of the upper portion of the card. This allows the card or cards to be attached or mounted to the front side of the base panel (10). The card or cards may be mounted with the reinforcing (38) front side facing outward. The cards or cards may then be detached from the front side of the base panel (10), turned over to display the punishing (44) back side and reattached (16) to the front side of the base panel (10).

A method for using the present invention is comprised of:

a. Instruct said child in exactly which desired behavior or act will result in a positive reinforcer card (36,38,40) being displayed on the base panel. Decide how many positive reinforcer (36,38,40) cards are needed for a child to receive a reward.

b. Instruct said child in exactly which undesired behavior or act will result in a punisher card (42,44,46) being displayed on the base panel. Decide how many punisher cards (42,44,46) are needed for the child to lose a reward.

c. As said child performs each desired behavior or act, one positive reinforcer card (36,38,40) is manually mounted to the front side of the base panel (10).

d. As said child performs each undesired behavior or act, one positive reinforcer card (36,38,40) is manually detached from the front side of the base panel and manually reattached (14,16,18) with the punisher card (42,44,46) now facing outward.

e. This process allows the parent, caregiver or educator to keep a running record of desirable and undesirable behavior with the simple flip of one or more cards from the positively reinforcing (38) front side to the punishing (44) back side. There may be any number of cards to represent any number of behaviors or actions.

Referring to FIG. 3, FIG. 4, FIG. 5 and FIG. 6 it is understood that pictorial representations may be used in place of the basic ‘happy face’ or ‘smiley’ and ‘sad face’ or ‘frown’ designations, especially where specific behavior may be targeted for change.

Referring to FIG. 1 and FIG. 2, it is understood that various shapes, such as a circle or disc may be used in place of the basic base panel and removable rectangular shaped cards.

For the purpose of illustrating this invention, a preferred embodiment is shown in this drawing. It is understood that this drawing is for purpose of example only and that the invention is not limited thereto. Changes and modifications may be made to the invention as will be readily apparent to those skilled in the art. Those changes and modifications will be made within the scope, spirit and teaching of this invention as defined by the claims.

1. A behavior modification recording device comprising a base panel having at least one removable card attached on the front of said base panel, said removable card comprises marking indicia representing a positive reinforcer on the card's front side and marking indicia representing a punisher on the card's back side.

2. The behavior modification recording device of claim 1 wherein each of said removable card attaches to said base panel enabling a parent, caregiver or educator to instruct a child on the function of each side of said removable card.

3. The behavior modification recording device of claim 1 wherein said parent, caregiver or educator instructs a child that when the card is turned front-side out, the marking indicia correspond to a positive reinforcer or reward for the child.

4. The behavior modification recording device of claim 1 wherein said parent, caregiver or educator instructs a child that when the card is turned back-side out, the marking indicia correspond to removal of a positive reinforcer or reward.

5. The behavior modification recording device of claim 3 allows said parent, caregiver or educator to keep a running record of desirable behavior with the simple flip of one or more cards from the positively reinforcing front-side to the punishing back-side.

6-8. (Canceled)

9. A method for parents, caregivers and educators to discipline a child without spanking, yelling, ignoring or time-outs comprising the steps of:
instructing said child in exactly which desired behavior or act results in a positive reinforcer card being attached and displayed on a base panel;
determining how many positive reinforcer cards are needed for said child to receive a reward;
instructing said child in exactly which undesired behavior or act results in a punisher card being attached and displayed on said base panel;
determining how many punisher cards are needed for said child to lose a reward; and
using said positive reinforcer card as an intrinsic reward by itself.

10. The method as recited in claim 9 further comprises the step of allowing said parent, caregiver or educator to include the child in operationally defining the behavior or act necessary to receive said positive reinforcer card or an extrinsic reward and to participate in determining said reward for performing the desired behavior or act.

11. The method as recited in claim 9 further comprises the step of allowing said parent, caregiver or educator to include the child in operationally defining the behavior or act necessary to receive a withdrawal of said positive reinforcer card or an extrinsic reward and to participate in determining an item to be withdrawn for performing the undesired behavior or act.

12-13. (Canceled)

14. The behavior modification recording device of claim 4 allows the parent, caregiver or educator to keep a running record of undesirable behavior with the simple flip of one or more cards from the positively reinforcing front-side to the punishing back-side.

15. The method as recited in claim 9 further comprises the step of using said positive reinforcer card as an intrinsic reward by itself.

16. The method as recited in claim 9 further comprises the step of pairing said step of providing said reinforcement card with the step of providing an extrinsic reward such as money, edible treats, TV time, token toys or stickers, movies, addition of a privilege, video game playing time, books to be read at bedtime, or trips to the playground.

17. The method as recited in claim 9 further comprises the step of using said punisher card as a punisher in and of itself.

18. The method as recited in claim 9 further comprises the step of pairing said step of providing said punisher card with the step of withdrawing any extrinsic reward such as money, edible treats, TV time, token toys or stickers, movies, addition of a privilege, video game playing time, books to be read at bedtime, or trips to the playground.

19. The method as recited in claim 9 further comprises the step of providing on said positive reinforcer card one of a pictorial representation, a happy face or a sad face.

20. The method as recited in claim 9 further comprises the step of providing said positive reinforcer card and said punisher card in varying shapes including a circle or a rectangle.

21. A behavior reinforcement and modification device for young children comprising;
a panel having a plurality of spaced-apart pegs extending outwardly from a front surface of said panel, a first row of said pegs being located a predetermined distance from a top edge of said panel;
a plurality of double-sided cards, a first side of said cards provides a positive behavior indication and a second side of said cards provides a negative behavior indication; and
means for removably attaching each one of said double-sided cards to one of said plurality of pegs.

22. The behavior reinforcement and modification device as recited in claim 21 wherein said removably attaching means comprises an aperture for each one of said plurality of pegs to fit through.

23. The behavior reinforcement and modification device as recited in claim 21 wherein said panel comprises an upper portion for identifying a child and a lower portion for positioning at least three of said plurality of pegs in a predetermined order.

24. The behavior reinforcement and modification device as recited in claim 21 wherein said panel comprises a flat, sturdy material.

25. The behavior reinforcement and modification device as recited in claim 21 wherein a back surface of said panel comprises means for mounting said panel.

26. The behavior reinforcement and modification device as recited in claim 21 wherein said first side of said cards comprises a pictorial representation of a happy face.

27. The behavior reinforcement and modification device as recited in claim 21 wherein said second side of said cards comprises a pictorial representation of a sad face.

28. A method of providing reinforcement and modification of a child's behavior comprising the steps of:
providing a panel having a plurality of space-apart pegs extending outwardly from a front surface of said panel;
locating a first row of said pegs a predetermined distance below a top edge of said panel;
placing at least one removable double-sided card on one of said pegs, a first side of said cards provides a positive behavior indication and a second side of said cards provides a negative behavior indication;
displaying a positive behavior indication on said first side of said card when a child has performed a desirable behavior; and
displaying a negative behavior indication on said second side of said card when said child has performed an undesirable behavior.

29. The method as recited in claim 28 wherein said step of placing a removably double-sided card on one of said pegs comprises the step of providing an aperture in said card for said peg to fit through.

30. The method as recited in claim 28 wherein said method comprises the step of providing a name of said child above said first row of said plurality of pegs.

31. The method as recited in claim 28 wherein said step of turning over said first side of said card indicating when a child has performed an undesirable behavior comprises the step of displaying a pictorial representation of a sad face.

32. The method as recited in claim 28 wherein said step of turning over said second side of said card indicating when a child has performed a desirable behavior comprises the step of displaying a pictorial representation of a happy face.

33. The method as recited in claim 28 wherein said method comprises the step of providing a running record of said desirable behavior and said undesirable behavior of said child.
